(19) United States
(12) Patent Application Publication
(10) Pub. No.: US 2004/0164577 A1
(43) Pub. Date: Aug. 26, 2004

(54) Adjustable armrest

(76) Inventors: Mohsen D. Shabana, Ann Arbor, MI (US); Christopher E. Borroni-Bird, Oakland Township, MI (US); Adrian B. Chernoff, Royal Oak, MI (US); Robert Louis Vitale, Macomb Township, MI (US); Philip Walter Leistra, Waterford, MI (US); Nancy J. Leistra, Waterford, MI (US); Eugenio Pagliano, Torino (IT)

Correspondence Address: KATHRYN A MARRA, General Motors Corporation, Legal Staff, Mail Code 482-C23-B21, P.O. Box 300, Detroit, MI, 48265-3000, US

(21) Appl. No.: 10/626,508

(22) Filed: Jul. 24, 2003

Related U.S. Application Data
(60) Provisional application No. 60/398,507, filed on Jul. 25, 2002.

(51) Int. Cl. B60N 2/46

(52) U.S. Cl. 296/1.09

(57) ABSTRACT

An adjustable armrest system for use in a vehicle includes an armrest having a support portion which is adjustably connected to the vehicle body. The support portion is pivotally mounted to the vehicle body for movement between a first position in which the support portion is generally horizontal and presents itself for use by a vehicle occupant and a second position in which the support portion is stowed in a generally vertical position so as to provide more space to the vehicle occupant. Preferably, the armrest is flush with the vehicle body when stowed in the second position. The armrest may be power-operated by a power mechanism including a motor and at least one linkage.

This application claims priority of U.S. Provisional Application Ser. No. 60/398,507 filed Jul. 25, 2002.

### TECHNICAL FIELD

The present invention relates to an armrest for use in a vehicle body. More particularly, this invention relates to an armrest that is adjustable to different positions to accommodate various vehicle occupants.

### BACKGROUND OF THE INVENTION

It is well known in the prior art to provide a vehicle armrest such that a vehicle occupant may rest their arm thereon. It is also known in the prior art to provide an armrest that is mounted on the vehicle door in a fixed position. This fixed armrest is positioned such that it attempts to provide comfort to occupants of all sizes from a single position.

It is also known in the prior art to provide an armrest mounted to a vehicle seat. It may be mounted in a stationary position, or more commonly, by pivotal connection. Sometimes these armrests flip up and down around the pivot point for easy entrance and exit from the seat. However, they are still in a fixed longitudinal, transverse and vertical position. Furthermore, it is known to have a console in a vehicle that may also function as an armrest. Typically, these have lids that can be opened or closed, but the armrest is still always in the same general position while usable as an armrest.

It would be desirable to provide an armrest that could be reconfigured to adjusted in the vertical, transverse, and/or horizontal directions or any angular combination thereof to comfortably custom adjust for all sizes of vehicle occupants. It would also be desirable to provide an armrest that can be conveniently moved between a stowed and a usable position and wherein the armrest is flushly mounted with the vehicle body in the stowed position. It would further be desirable to provide a power-operated armrest that is automatically adjustable by the vehicle occupant.

### SUMMARY OF THE INVENTION

This invention is an adjustable armrest system for use in a vehicle body. The system includes an armrest having a support portion. The support portion is operatively connected to the vehicle, and is pivotally mounted to the vehicle body for rotation between a first position in which the support portion is generally horizontal and presents itself for use by a vehicle occupant and a second position in which the support portion is stowed in a generally vertical position as to provide more space to the vehicle occupant.

The support portion is adjustably connected to the vehicle body for movement between an upper position and a lower position such that the vertical height of the armrest can be adjusted for the comfort of the vehicle occupant.

The support portion is also adjustably connected to the vehicle body for movement between a forward position and a rearward position such that the longitudinal position of the armrest can be adjusted for the comfort of the vehicle occupant.

The support portion is adjustably mounted to the vehicle body for movement between an upper position and a lower position such that the vertical height of the armrest can be adjusted for the comfort of the vehicle occupant and wherein the support portion is also adjustably mounted to the vehicle body along the longitudinal axis for movement between a forward position and a rearward position such that the longitudinal position of the armrest can also be adjusted for the comfort of the vehicle occupant.

The adjustable armrest system includes a control device which provides occupant input command for at least one vehicle function selected from the group consisting of a window position control, a radio control, a mirror control, a vehicle climate control, a seat adjustment control, and an armrest adjustment control. The control could also be a by-wire driver control-seat control, head phone hook-up-computer/internet port or any other type of vehicle control or computer control.

The armrest may be power-operated for power adjustment by the vehicle occupant. The support portion may be positionable at any angled position along its path of rotation between the horizontal and vertical positions.

For this purpose, the armrest system includes a power mechanism for adjusting the armrest. The power mechanism comprises a motor, and at least one linkage element operatively connecting the motor to the support portion. Operation of the motor imparts movement to the support portion via the linkage element such that the support portion is movable between first and second positions. The power mechanism is housed within the armrest or armrest module. The motor is irreversible. The armrest or armrest module includes a mounting portion and a support portion which is pivotally connected to the mounting portion. The mounting portion houses a motor. A control device may be provided on the armrest for inputting a signal to the motor to direct the power adjustment of the armrest.

The vehicle body may have a vehicle seat or console and the armrest may be adjustably connected to the vehicle seat or the console. The vehicle body may have a door and the armrest can be independent of the seat and the door. In this arrangement, the support portion could be directly mounted to the vehicle body side rather than onto the door or the seat. When the vehicle body includes a vehicle door, the vehicle door may have a recessed portion and so that the armrest module fits flushly within the recessed portion of the door when the armrest is stowed in the down position.

The invention is also an adjustable armrest for use in a vehicle body. The armrest has a support portion. The support portion is adapted for adjustable connection to the vehicle body and has a rotational axis. The support portion may be pivotally mounted to the vehicle body for rotation about the rotational axis between a first position in which the support portion is generally horizontal and presents itself for use by a vehicle occupant and a second position in which the support portion is stowed in a generally vertical position so as to provide more space to the vehicle occupant.

The above objects, features and advantages, and other objects, features and advantages of the present invention are readily apparent from the following detailed description of the best modes for carrying out the invention when taken in connection with the accompanying drawings.

### BRIEF DESCRIPTION OF THE DRAWINGS

FIG. 1 is a fragmentary perspective view from the right side of a passenger vehicle with parts broken away to show an interior with the adjustable armrests of the invention;

FIG. 2 is a fragmentary perspective view like FIG. 1, but from the left side;

FIG. 3 is a perspective view of an armrest portion of a vehicle door with the armrest pivoted to a partially open position;

FIG. 4 is a side elevation of the armrest portion of a vehicle door with armrest control buttons;

FIG. 5 is an elevation of the armrest module for a vehicle door with the armrest portion of the module in section and in a closed position (solid line) and an open position (phantom line);

FIG. 6 is a side elevation of the armrest portion of the module for a vehicle door with the armrest portion partially folded down and without armrest control buttons;

FIG. 7 is a perspective view of an armrest module for a vehicle door with the armrest portion partially open and with control buttons thereon;

FIG. 8 is a schematic of the front seating of a vehicle interior with flanking adjustable armrests in the open arm support position on modules positioned for installation in a recess of a vehicle door;

FIG. 9 is a schematic perspective of the rear seating of a vehicle interior with an adjustable armrest in the closed position on a rear vehicle door;

FIG. 10 is a fragmentary side view of a vehicle sedan's interior with the installed adjustable armrest modules on the doors on both sides of the vehicle and in the closed position;

FIGS. 11 and 11a are respectively side and end views of an adjustable armrest with a motor-operated linkage for moving the armrest between open and closed positions;

FIG. 12 is a schematic sectional view of another armrest embodiment adjustable to a series of vertical support positions selectively suitable for supporting an arm of differently sized vehicle occupants;

FIG. 13 is another view of the vertically adjustable armrest of FIG. 12 showing how the armrest may be moved to a stowed position;

FIG. 14 is a perspective view of the inside of a vehicle door with the vertically adjustable armrest of FIGS. 12 and 13 also being adjustable fore and aft;

FIG. 15 is a perspective view of the inside of a vehicle door with an articulated armrest embodiment which is foldable to a stowed position and movable up and down on a track; and

FIG. 16 is a schematic sectional view of a vehicle door with the articulated armrest of FIG. 15 movable between upper and lower positions and which folds one way to increase the armrest support area and folds another way to collapse the armrest for movement to the stowed position.

### DESCRIPTION OF THE PREFERRED EMBODIMENTS

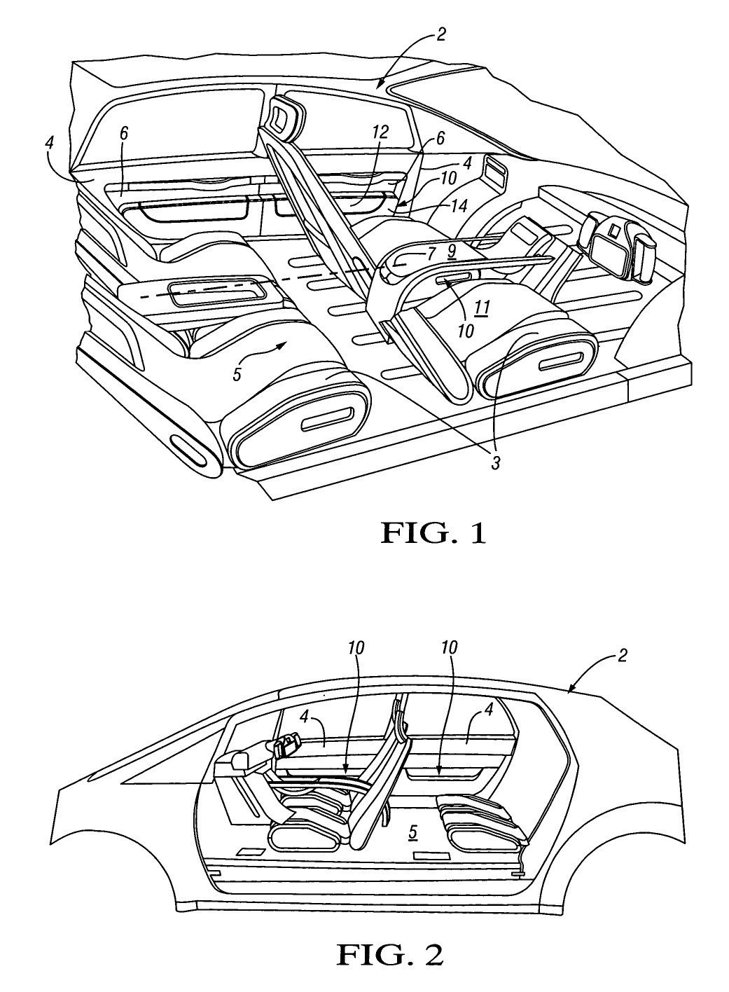

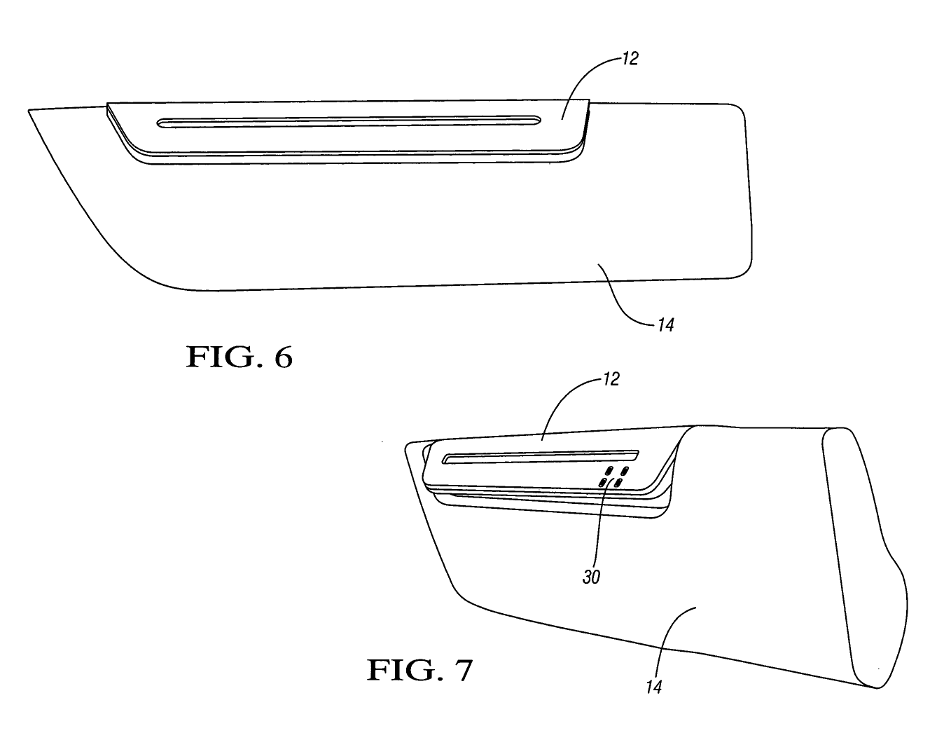

As best shown in FIGS. 1-2, a vehicle body 2 includes a vehicle interior 5 having vehicle seats 3 therein. The vehicle body 2 has a longitudinal axis 7 that extends along the length of the vehicle body 2. A vehicle occupant may be seated in any vehicle seat 3. In accordance with this invention, the vehicle includes an armrest 10 that is preferably mounted on a left side and/or right side vehicle door 4 or to a console 9 or seat 11, as in FIG. 1. As best shown in FIGS. 1-8 in a preferred embodiment of the invention, each door 4 preferably has a recessed portion 6 which is sized and shaped for receiving the armrest 10 flushly therein as described further hereinafter.

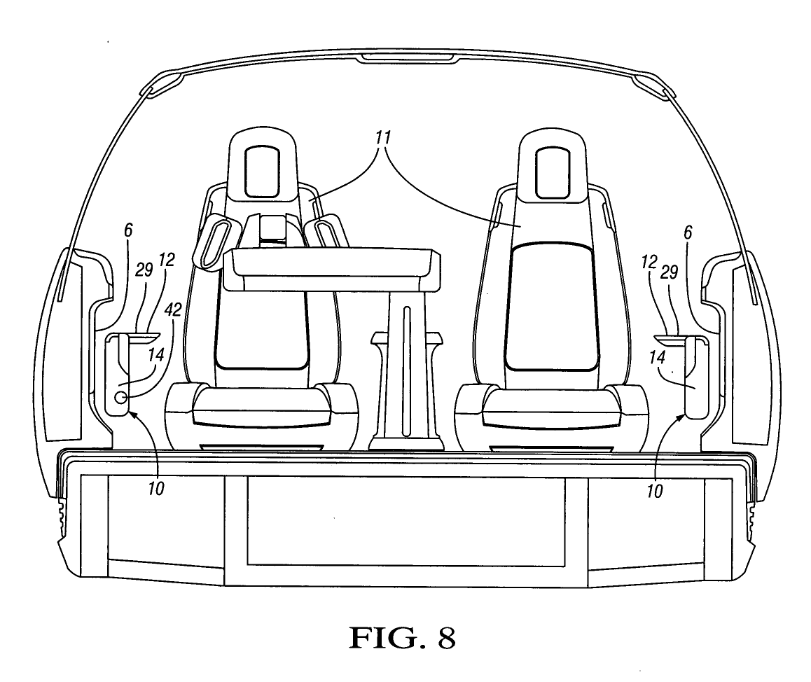

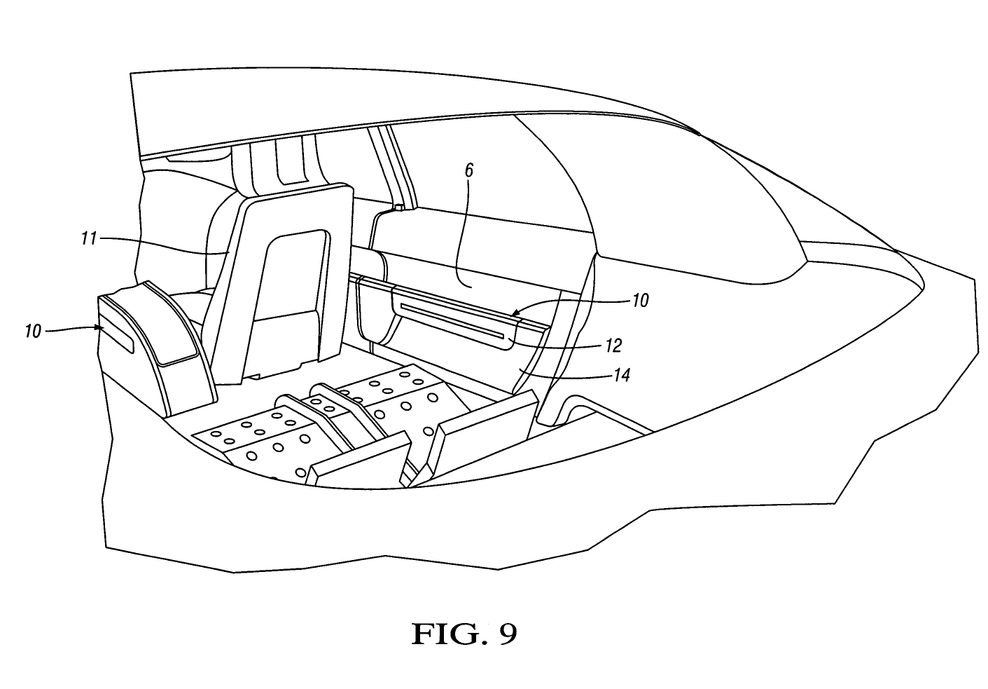

The armrest 10 is preferably made of materials typical for armrests as known in the prior art. As best shown in FIG. 5, the armrest 10 may include a substrate 23 made of sturdy metal or plastic covered by a foam material 25 which is covered by a decorative cover 27, such as cloth, leather, vinyl or plastic. In one preferred embodiment of this invention shown in FIG. 8, the armrest 10 has an outer upper surface 29 covered with a leather material.

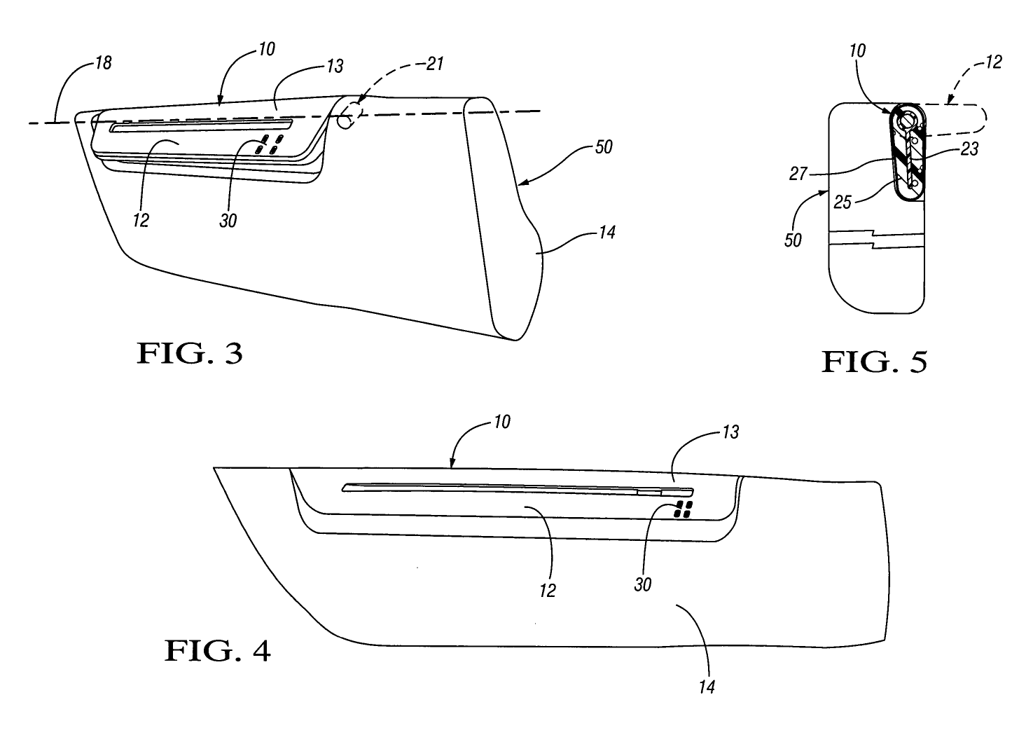

Preferably, the armrest 10 has a support portion 12 that is adjustably connected t the vehicle door 4. As best shown in FIG. 3, the support portion 12 has a longitudinal rotational axis 18 that is generally parallel to the longitudinal axis 7 of the vehicle body 2. However, as shown in FIGS. 3-5 and 11, the rotational axis may be tilted depending on the styling desired for the door 4 and armrest 10. the support portion 12 is adapted to be pivotally mounted to the vehicle body 2 by a pivot mechanism 21 for rotation about the rotational axis 18 between a generally horizontal first position in which the support portion 12 presents itself for use by a vehicle occupant (FIG. 8) and a generally vertical second position in which the support portion 12 is stowed to provide more space to the vehicle occupant when the armrest is not in use (FIG. 10).

As best shown in FIGS. 3-5, the armrest 10 is comprised of support portion 12 that is pivotally connected to a mounting portion 14 along the rotational axis 18 by the pivot mechanism 21. The support portion 12 is operatively connected to the vehicle body 2 or door 4, either directly or indirectly such as through the mounting portion 14 of the armrest 10, as described further hereinafter. The support portion 12 is pivotally mounted in any suitable manner such that the support portion 12 can be pivoted, such as by a rod or hinge.

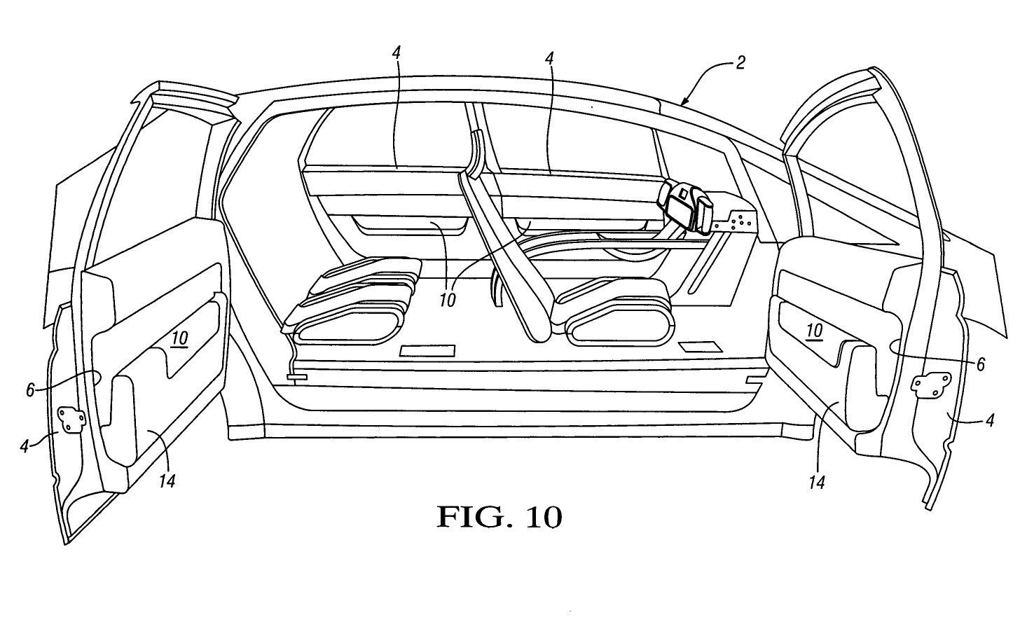

As best shown in FIG. 8, the armrest may also include the mounting portion 14 which could be of various sizes either larger or smaller than the support portion 12 of the armrest 10, depending on the intended styling effect desired. The mounting portion 14 may also serve as a decorative door insert and could be of any suitable construction, such as a plastic or metal substrate covered by foam and/or a decorative material or could be a composite element. As best shown in FIGS. 1 and 2 and also in FIGS. 9 and 10, the armrest 10 fits flushly within the recessed portion 6 of the door 4, but does not fill the entire recessed portion 6 of the door 4 which may be sized larger than the armrest 10. This creates an aesthetically pleasing styling effect on the door 4 as best seen in FIGS. 1 and 2. It will further be appreciated that the armrest 10 could be sized to fill the entire recessed portion 6 of the door 4, if desired.

As best shown in FIG. 5, the support portion 12 functions such that it is locked into the horizontal first position (phantom lines) when the armrest 10 is in use, and then can readily be unlocked and pushed down by the vehicle occupant when it is desired to be rotated to the stowed vertical second position (solid line). This adjustable function can be accomplished with a variety of mechanical hardware such as a spring-loaded device (similar to that for a cupholdler) or by a detent gear or in any other suitable manner. It will also be appreciated that adjustability of the armrest 10 could be accomplished manually by the occupant physically rotating the armrest 10 or by power operation, as will now be described.

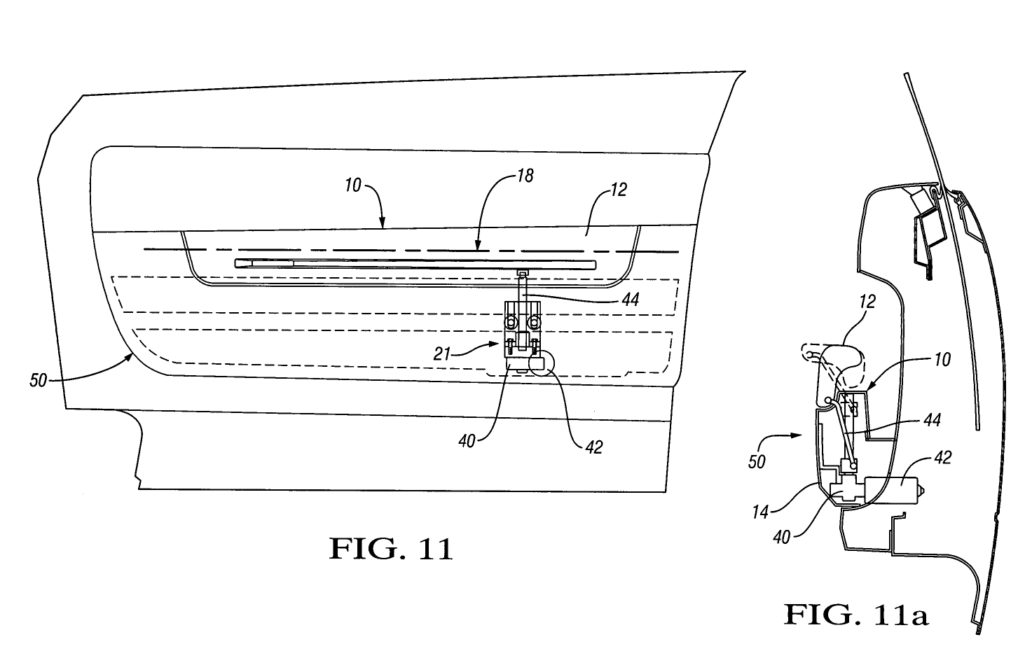

Advantageously, the armrest 10 may be power-operated for power adjustment by a vehicle occupant. As shown in FIGS. 11 and 11a, the armrest 10 includes a power mechanism 40 for adjusting the armrest. The power mechanism 40 includes a motor 42 and at least one linkage element 44 operatively connecting the motor 42 and the support portion 12. During operation, the motor 42 imparts movement to the support portion 12 via the linkage element 44 such that the support portion 12 is movable between the first and second positions. Preferably, the motor 42 is an irreversible motor, whereby the support portion 12 can be held in position. While the support portion 12 is preferably held in either the first or second positions, it will be appreciated that the support portion 12 could also be held in place by the linkage element 44 at any point along its path of motion between the first and second positions. The mounting portion 14 and the support portion 12 generally form an L-shape when the support portion is in the up position. The support portion 12 is generally flush with the mounting portion when the support portion is stowed.

Also, the power mechanism 40 is housed within the armrest 10. For example, the power-operated armrest 10 can have a modular construction as best shown in FIGS. 8 and 10. The power armrest module 50 includes the mounting portion 14 with the motor 42 housed in the mounting portion 14 and the linkage element 44 extending out through the mounting portion 14 for connection to the support portion 12. Thus, the armrest 10 (including the support portion 12 and the mounting portion 14) and the power mechanism 40 (including the motor 42 and the linkage element 44) provide the armrest module 50. It will be appreciated that power mechanism 40 could alternately be mounted in the support portion 12 or in the vehicle door 4.

As best shown in FIGS. 1-8, the armrest 10 is preferably generally flush with the vehicle door 4 when it is in the stowed position. The armrest 10 preferably is sized and shaped for fitting flushly within the recessed portion 6 of the door 4 when the armrest 10 is in the stowed vertical second position.

As shown in FIGS. 3 and 4, the armrest 10 may also optionally have control devices 30 mounted thereon. The support portion 12 preferably has at least one control device 30 for driver or passenger inputs to command a vehicle function. The control devices 30 could be in the form of buttons, switches, joy sticks or other suitable control elements. For example, possible functions of the control devices 30 could be to provide input for a window position control, radio control, mirror control, vehicle climate control, seat adjustment control and/or an armrest adjustment control or any other control input for a vehicle function. For example, the armrest 10 can be automatically positioned by using the control device 30 as input which commands the motor 42 and linkage element 44 attached thereto. It will be appreciated that the control device 30 for power adjustment of the armrest 10 could also be positioned remotely from the armrest 10 on the vehicle instrument panel or console.

While a preferred embodiment of the invention has been described, it will be appreciated that other embodiments are also possible. For example, while the armrest 10 in FIG. 3 is shown being rotated about an upper edge 13 of the support portion 12, the armrest 10 can also be rotated about its lower edge (as in FIG. 13) such that the face adjacent the door 4 in the stowed position becomes the upper surface of the armrest. In this manner, it is simpler to provide a mechanical stop mechanism for holding the support portion 12 in the horizontal second position. While the armrest 10 is shown as being connected to a mounting portion 14 of the vehicle door 4, it will be appreciated that the armrest can be connected anywhere on the vehicle, including an interior console, a vehicle seat, or other part of the vehicle body where an occupant's arm is likely to repose.

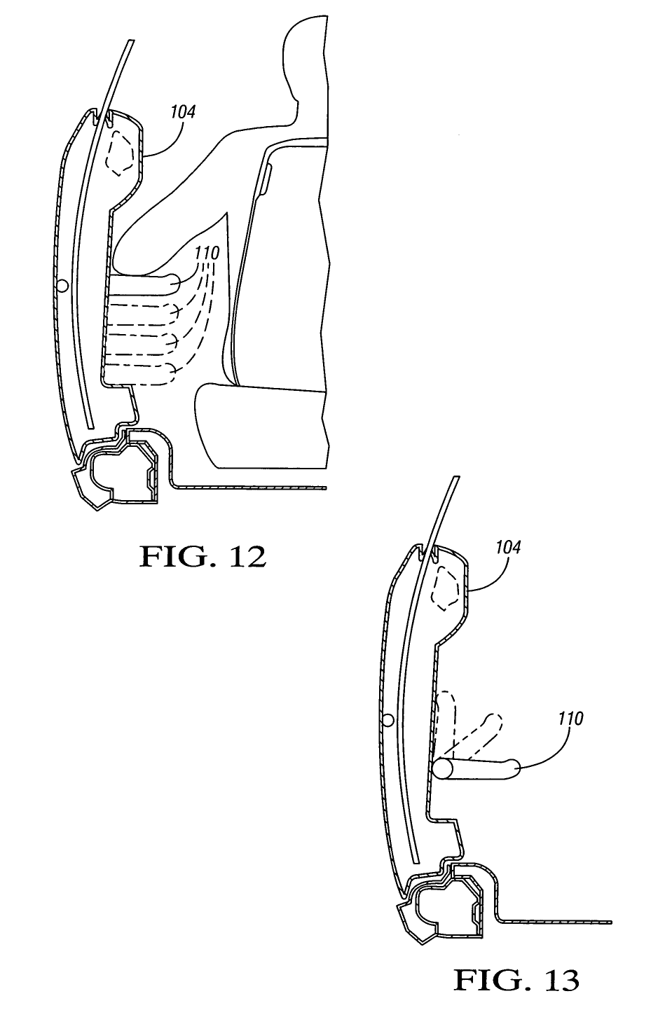

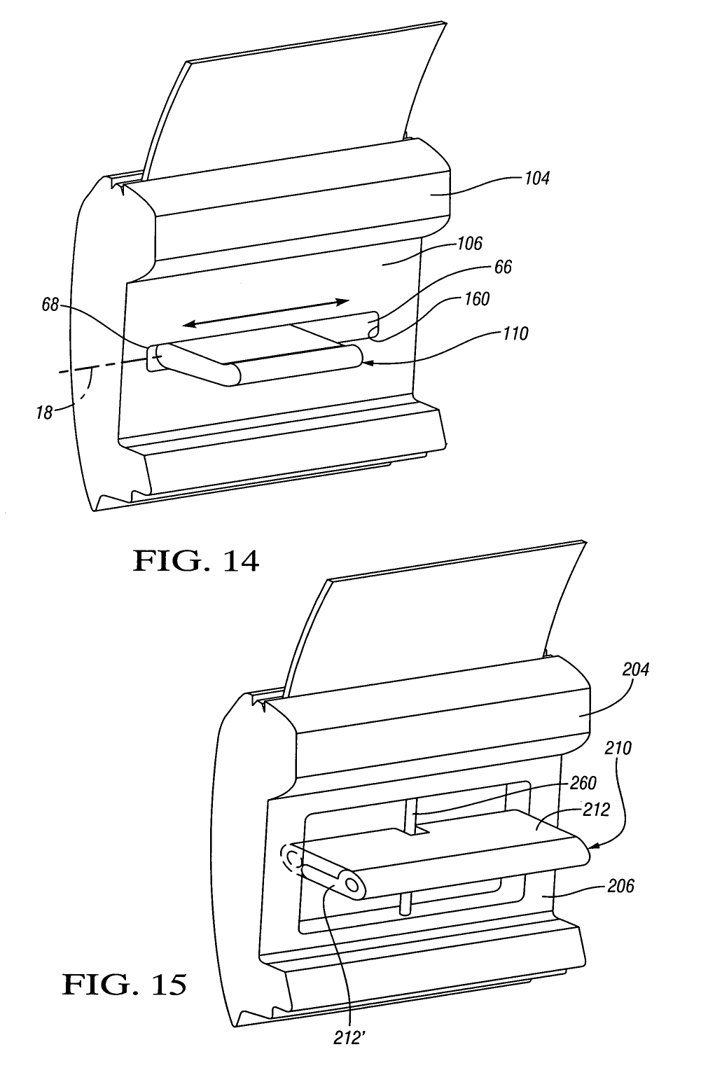

FIGS. 12, 13 and 14 show a space-saving embodiment wherein the armrest 110 is adjustable vertically up and down (FIG. 12), is stowable (FIG. 13), and adjustable fore and aft (FIG. 14). Similar elements have similar numerals plus 100. In addition, FIG. 14 shows the embodiment of the invention in which the armrest 110 is adjustable between a forward position 66 and a rearward position 68. This arrangement can also be power-operated by a suitable motor and linkage or be manually operated. This forward and rearward adjustment could be alone or in addition to the rotational movement of the armrest 10 described above. For example, the armrest 110 could move forward and rearward within the recessed portion 106 of the door 104 on a track 160.

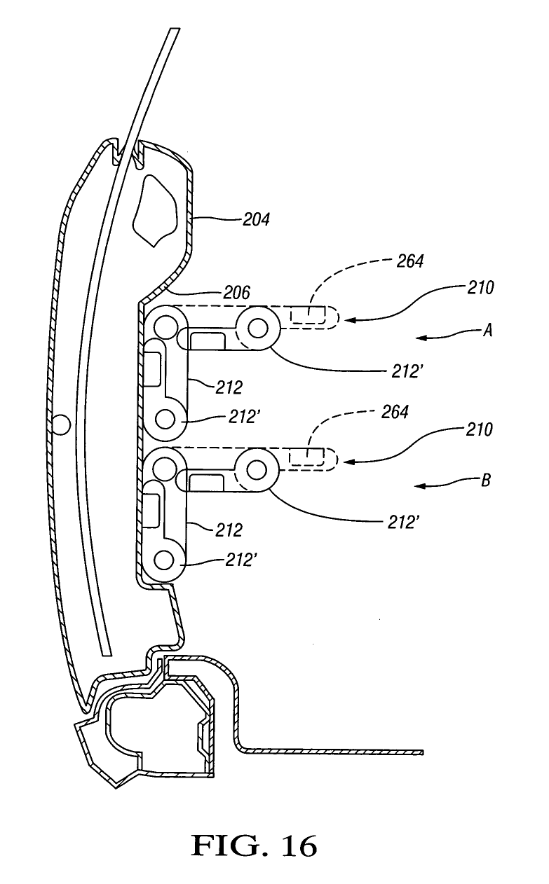

Furthermore, FIGS. 15 and 16 show an alternate embodiment of the invention in which the armrest 210 is adjustable between an upper position A and a lower position B. This arrangement can also be power-operated by a suitable motor and linkage or be manually operated. This up and down adjustment could be alone or in addition to the rotational movement of the armrest 10 described above. For example, the armrest 210 could move up and down within the recessed portion 206 of the door 204. In addition, the armrest 210 may move along a track 160 in the door (not shown) but similar to track 160 in FIG. 14. FIG. 16 shows the armrest 210 in the upper and lower positions.

FIGS. 15 and 16 also demonstrate yet another alternate embodiment of the invention in which the support portion 212 may include an additional segmented extender portion 212′ that may also be flipped up or down. This extender portion 212′ extends the support portion when desired such as for use as a tray by the vehicle occupant. This extender portion 212′ may even include a cupholder 264.

While the best modes for carrying out the invention have been described in detail, those familiar with the art to which this invention relates will recognize various alternative designs and embodiments for practicing the invention within the scope of the appended claims.

1. An adjustable armrest system for use by an occupant in a vehicle body comprising:
an armrest having a support portion; and
the support portion being pivotally mounted with respect to the vehicle body for rotation between a first position in which the support portion is sufficiently horizontal to present itself for use by the vehicle occupant and a second position in which the support portion is stowed in a sufficiently vertical position as to provide more space for the occupant in the vehicle body.

2. The adjustable armrest system of claim 1 wherein the armrest is power-operated for power adjustment by a vehicle occupant.

3. The adjustable armrest system of claim 1 wherein the armrest system includes a power mechanism for adjusting the support portion, the power mechanism comprising: a motor, and at least one linkage element operatively connecting the motor to the support portion, wherein operation of the motor imparts movement to the support portion via the linkage element such that the support portion is movable between the first and second positions.

4. The adjustable armrest system of claim 3 wherein the armrest is a module and the power mechanism is housed within the module.

5. The adjustable armrest system of claim 3 wherein the motor is irreversible.

6. The adjustable armrest system of claim 2 wherein the support portion is positionable at any angled position along its pivotal path between the first and second positions.

7. The adjustable armrest system of claim 3 wherein the armrest includes a mounting portion and wherein the support portion is pivotally connected to the mounting portion and wherein the mounting portion houses the motor.

8. The adjustable armrest system of claim 3 including a control device on the armrest for controlling the motor to direct the power adjustment of the support portion.

9. The adjustable armrest system of claim 1 wherein the support portion is adjustably connectable to the vehicle body for movement between an upper position and a lower position such that the vertical height of the armrest can be adjusted for the comfort of the vehicle occupant.

10. The adjustable armrest system of claim 1 wherein the support portion is longitudinally adjustably movable with respect to the vehicle body for movement between a forward position and a rearward position such that the longitudinal position of the support portion is adjustable for the comfort of the vehicle occupant.

11. The adjustable armrest system of claim 1 wherein the support portion is adjustably mounted to the vehicle body for movement between an upper position and a lower position such that the vertical height of the armrest is adjustable for the comfort of the vehicle occupant and wherein the support portion is also adjustably mounted to the vehicle body along the longitudinal axis for movement between a forward position and a rearward position such that the longitudinal position of the armrest can also be adjusted for the comfort of the vehicle occupant.

12. The adjustable armrest system of claim 1 wherein the vehicle body has a vehicle seat and wherein the armrest is adjustably connected with respect to the vehicle seat.

13. The adjustable armrest system of claim 1 wherein the armrest includes a mounting portion connected to the support portion and wherein the mounting portion is connectable to the vehicle body and wherein the support portion is connected to the mounting portion.

14. The adjustable armrest system of claim 7 wherein the mounting portion and the support portion generally form an L-shape when the support portion is in the first position and wherein the support portion is generally flush with the mounting portion when the support portion is stowed in the second position.

15. The adjustable armrest system of claim 1 wherein the vehicle body has a vehicle door and wherein the armrest is flushly mounted within the vehicle door when the support portion is stowed in the second position.

16. The adjustable armrest system of claim 1 wherein the vehicle body includes a vehicle door and wherein the vehicle door has a recessed portion and wherein the armrest fits flushly within the recessed portion of the door when the armrest is stowed in the second position.

17. The adjustable armrest system of claim 1 wherein the vehicle body has a vehicle door and wherein the armrest forms a module as part of the vehicle door.

18. The adjustable armrest system of claim 1 wherein the support portion has at least one control device for occupant command to the vehicle.

19. The adjustable armrest system of claim 18 wherein the control device provides occupant input command for at least one vehicle function selected from the group consisting of a window position control, a radio control, a mirror control, a vehicle climate control, a seat adjustment control, and an armrest support portion rotation control.

20. The adjustable armrest system of claim 18 wherein the control device provides occupant input command for adjustment of the armrest support portion position.

21. An adjustable armrest for use in a vehicle body comprising:
an armrest having a support portion;
the support portion adjustably connectable to the vehicle body; and
the support portion having a rotational axis and being pivotally mountable to the vehicle body for rotation about the rotational axis between a first position in which the support portion is generally horizontal and presents itself for use by a vehicle occupant and a second position as to provide more space to the vehicle occupant.

22. An adjustable armrest for use in a vehicle body comprising:
an armrest having a support portion; and
the support portion being adjustably connectable to the vehicle body for movement between an upper position and a lower position such that the vertical height of the armrest can be adjusted for the comfort of the vehicle occupant.

23. An adjustable armrest for use in a vehicle body comprising:
an armrest having a support portion; and
the support portion being adjustably connectable to the vehicle body for movement between a forward position and a rearward position such that the longitudinal position of the armrest can be adjusted for the comfort of the vehicle occupant.

24. A vehicle body having an adjustable armrest system for use in the vehicle body comprising:
an armrest mounted to the vehicle body; and
the armrest having a power mechanism for moving the armrest between a first position and a second position.

25. The adjustable armrest system in the vehicle body of claim 24 further comprising:
the armrest having a support portion;
the support portion being operatively connected to the vehicle body; and
the support portion being pivotally mounted with respect to the vehicle body for rotation between a first portion in which the support portion is generally horizontal and presents itself for use by a vehicle occupant and a second position in which the support portion is stowed in a generally vertical position as to provide more space to the vehicle occupant.

26. The adjustable armrest system in the vehicle body of claim 24 wherein the power mechanism comprises an operable motor and at least one linkage element operatively connecting the motor to the support portion, and wherein operation of the motor imparts movement to the support portion via the linkage element such that the support portion is movable between the first and second positions.

27. The adjustable armrest system in the vehicle body of claim 24 wherein the power mechanism is housed within the armrest.

28. The adjustable armrest system in the vehicle body of claim 24 wherein the power mechanism includes a motor which is irreversible.

29. The adjustable armrest system in the vehicle body of claim 24 wherein the armrest is movable to any location along its path of movement between the first and second positions.

30. The adjustable armrest system in the vehicle of claim 24 wherein the armrest includes a mounting portion and a support portion pivotally connected to the mounting portion and wherein the mounting portion houses the power mechanism.

31. The adjustable armrest system in the vehicle of claim 24 wherein a control device is provided on the armrest for inputting a signal to the power mechanism to direct the powered movement of the armrest.
